(19) United States
(12) Patent Application Publication
(10) Pub. No.: US 2016/0114359 A1
(43) Pub. Date: Apr. 28, 2016

(54) LIQUID DISPENSER WITH IMPROVED DRIP PREVENTION

(71) Applicant: LAM RESEARCH AG, Villach (AT)

(72) Inventors: Anders Joel BJORK, VILLACH (AT); David HENRIKS, VILLACH (AT); Alex EDER, MALLENITZEN (AT)

(21) Appl. No.: 14/526,301

(22) Filed: Oct. 28, 2014

(51) Int. Cl. B08B 3/04; B08B 3/08

(52) U.S. Cl. CPC B08B 3/04; B08B 3/08

(57) ABSTRACT

In an apparatus for treating a wafer-shaped article, a spin chuck is provided for holding and rotating a wafer-shaped article. A liquid dispenser comprises a supply conduit that divides to form a first branch extending toward a dispensing outlet of the liquid dispenser and a second branch communicating with a vent opening of the liquid dispenser. The second branch extends upwardly relative to the first branch over at least a portion of its length.

### BACKGROUND OF THE INVENTION

1. Field of the Invention

The invention relates to a liquid dispenser with improved drip prevention. The invention is preferably embodied in methods and apparatus for liquid treatment of wafer-shaped articles.

2. Description of Related Art

Liquid treatment includes both wet etching and wet cleaning, wherein the surface area of a wafer to be treated is wetted with a treatment liquid and a layer of the wafer is thereby removed or impurities are thereby carried off. A device for liquid treatment is described in U.S. Pat. No. 4,903,717. In this device the distribution of the liquid may be assisted by the rotational motion imparted to the wafer.

Techniques for etching and cleaning a surface of a disc-shaped article are typically used in the semiconductor industry after cleaning a silicon wafer during production processes (e.g. pre-photo clean, post CMP-cleaning, and post plasma cleaning). However, such methods may be applied for other plate-like articles such as compact discs, photo masks, reticles, magnetic discs or flat panel displays. When used in semiconductor industry it may also be applied for glass substrates (e.g. in silicon-on-insulator processes), III-V substrates (e.g. GaAs) or any other substrate or carrier used for producing integrated circuits.

Single wafer tools such as that described in U.S. Pat. No. 4,903,717 are required to meet more stringent processing conditions as the size of the device features formed on the semiconductor wafer continues to decrease, and as the aspect ratio of those device features continues to increase. Furthermore, the trend toward usage of wafers of larger diameters means that the economic loss associated with a damaged wafer becomes greater. For example, the area of the incoming 450 mm diameter standard silicon wafer is 125% greater than that of the outgoing 300 mm diameter standard silicon wafer, which itself was 125% greater than that of the preceding generation 200 mm diameter standard silicon wafer.

### SUMMARY OF THE INVENTION

The present invention is based in part on the recognition by the present inventors that stray droplets from the liquid dispensers utilized in processing equipment of the type described above, can result in significant damage to the workpiece and a higher loss of workpieces. The inventors evaluated various techniques in an effort to address this problem before discovering the efficacy of the techniques described herein.

Thus, in one aspect, the present invention relates to an apparatus for treating a wafer-shaped article, comprising a spin chuck for holding and rotating a wafer-shaped article, and a liquid dispenser that is connected to a supply of a process liquid and positioned or positionable so as to dispense the process liquid onto a surface of a wafer-shaped article when positioned on the spin chuck. The liquid dispenser comprises a supply conduit that divides to form a first branch extending toward a dispensing outlet of the liquid dispenser and a second branch communicating with a vent opening of the liquid dispenser. The second branch extends upwardly relative to the first branch over at least a portion of its length.

In preferred embodiments of the apparatus according to the present invention, the second branch is dimensioned and positioned relative to the first branch so as to maintain a fixed volume of process liquid therein during dispensing of the process liquid through the dispensing opening.

In preferred embodiments of the apparatus according to the present invention, the supply conduit and the first and second branches define a T-junction.

In preferred embodiments of the apparatus according to the present invention, the first branch extends downwardly from the supply conduit to the dispensing opening.

In preferred embodiments of the apparatus according to the present invention, the second branch extends upwardly from the supply conduit to the vent opening.

In preferred embodiments of the apparatus according to the present invention, the second branch extends upwardly from the supply conduit to a U-shaped curve, thence downwardly from the U-shaped curve to the vent opening.

In preferred embodiments of the apparatus according to the present invention, neither the first branch nor the second branch is equipped with a valve.

In preferred embodiments of the apparatus according to the present invention, the first and second branches are dimensioned and positioned relative to one another such that the second branch does not admit air to the first branch though the vent opening, and such that no liquid is discharged through the vent opening.

In preferred embodiments of the apparatus according to the present invention, the first branch extends downwardly from the supply conduit to a first U-shaped curve, thence upwardly from the first U-shaped curve to a second U-shaped curve, thence downwardly from the second U-shaped curve to the dispensing opening.

In preferred embodiments of the apparatus according to the present invention, a stopper is provided that is configured so as to at least partially block the dispensing opening, thereby to promote flushing of the second branch with liquid supplied through the supply conduit.

In another aspect, the present invention relates to a liquid dispenser for use in an apparatus for treating a wafer-shaped article, comprising a supply conduit that divides to form a first branch extending toward a dispensing outlet of the liquid dispenser and a second branch communicating with a vent opening of the liquid dispenser. The second branch extends upwardly relative to the first branch over at least a portion of its length.

In preferred embodiments of the liquid dispenser according to the present invention, the second branch is dimensioned and positioned relative to the first branch so as to maintain a fixed volume of process liquid therein during dispensing of the process liquid through the dispensing opening.

In preferred embodiments of the liquid dispenser according to the present invention, the supply conduit and the first and second branches define a T-junction.

In preferred embodiments of the liquid dispenser according to the present invention, the first branch extends downwardly from the supply conduit to the dispensing opening.

In preferred embodiments of the liquid dispenser according to the present invention, the second branch extends upwardly from the supply conduit to the vent opening.

In preferred embodiments of the liquid dispenser according to the present invention, the second branch extends upwardly from the supply conduit to a U-shaped curve, thence downwardly from the U-shaped curve to the vent opening.

In preferred embodiments of the liquid dispenser according to the present invention, neither the first branch nor the second branch is equipped with a valve.

In preferred embodiments of the liquid dispenser according to the present invention, the first and second branches are dimensioned and positioned relative to one another such that the second branch does not admit air to the first branch though the vent opening, and such that no liquid is discharged through the vent opening.

In preferred embodiments of the liquid dispenser according to the present invention, the first branch extends downwardly from the supply conduit to a first U-shaped curve, thence upwardly from the first U-shaped curve to a second U-shaped curve, thence downwardly from the second U-shaped curve to the dispensing opening.

In preferred embodiments of the liquid dispenser according to the present invention, a stopper is provided that is configured so as to at least partially block the dispensing opening, thereby to promote flushing of the second branch with liquid supplied through the supply conduit.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a schematic view of an apparatus according to a first embodiment of the invention;

FIG. 2 is a cross-sectional view of the liquid dispenser used in the apparatus of FIG. 1, showing the liquid level in a first state of processing;

FIG. 3 is a cross-sectional view of the liquid dispenser used in the apparatus of FIG. 1, showing the liquid level in a second state of processing;

FIG. 4 is a cross-sectional view of the liquid dispenser used in the apparatus of FIG. 1, showing the liquid level in a third state of processing;

FIG. 5 is a cross-sectional view of the liquid dispenser used in the apparatus of FIG. 1, after the liquid level has been completely removed from the dispenser;

FIG. 6 is a cross-sectional view of a liquid dispenser according to another embodiment of the present invention;

FIG. 7 is a cross-sectional view of a liquid dispenser according to yet another embodiment of the present invention; and

FIG. 8 is a cross-sectional view of a liquid dispenser as in FIGS. 2-5, illustrating the use of a stopper to aid in cleaning the dispenser.

### DETAILED DESCRIPTION OF PREFERRED EMBODIMENTS

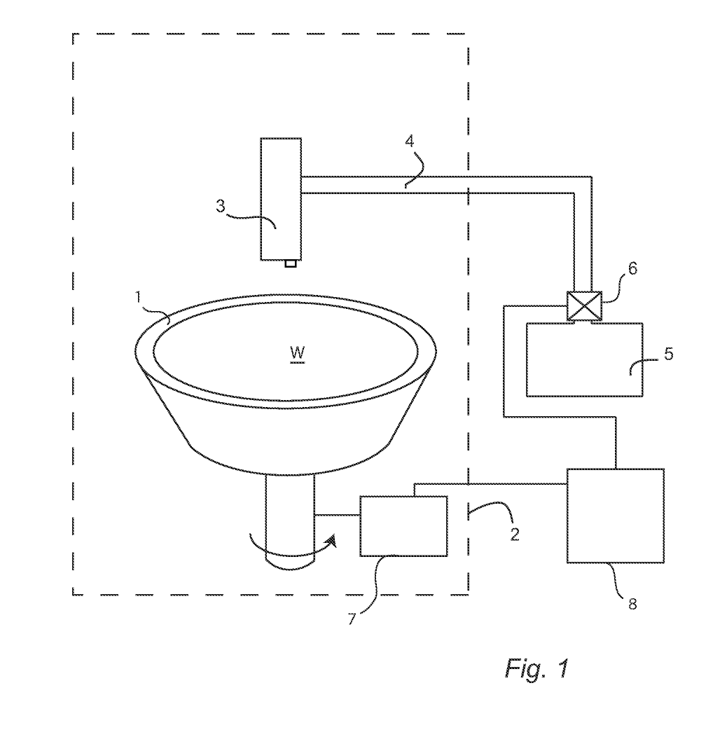

Referring now to the drawings, FIG. 1 depicts a spin chuck 1 that holds a wafer W thereon in a predetermined orientation, which is preferably such that the major surfaces of disposed horizontally or within ±20° of horizontal. Spin chuck 1 may for example be a chuck that operates according to the Bernoulli principle, as described for example in U.S. Pat. No. 4,903,717. Alternatively, spin chuck 1 may comprise a series of gripping pins that can support the full weight of wafer W in use.

Chuck 1 is typically present in a process module for single wafer wet processing of semiconductor wafers, and may or may not be positioned within a chamber 2. A liquid dispenser assembly is positioned above the chuck 1, and comprises a liquid dispenser arm 4 that is connected to a supply 5 of a process liquid, via a control valve 6. The liquid dispenser arm 4 comprises a liquid dispenser 3 at its distal end. The liquid dispenser arm and liquid dispenser 3 are shown in use position above the wafer W positioned on spin chuck 1. However, the dispenser arm 4 is preferably pivotable or movable linearly to a standby position in which it does not overlie the wafer W, to facilitate loading and unloading of wafers W on the spin chuck 1.

Spin chuck 1 is rotated via a lower shaft that in turn is driven in rotation by a motor 7. A controller 8 controls the overall operation of the spin chuck 1, including coordinating the action of motor 7 to rotate the chuck and the action of valve 6 to open and close the flow of process liquid from the supply 5.

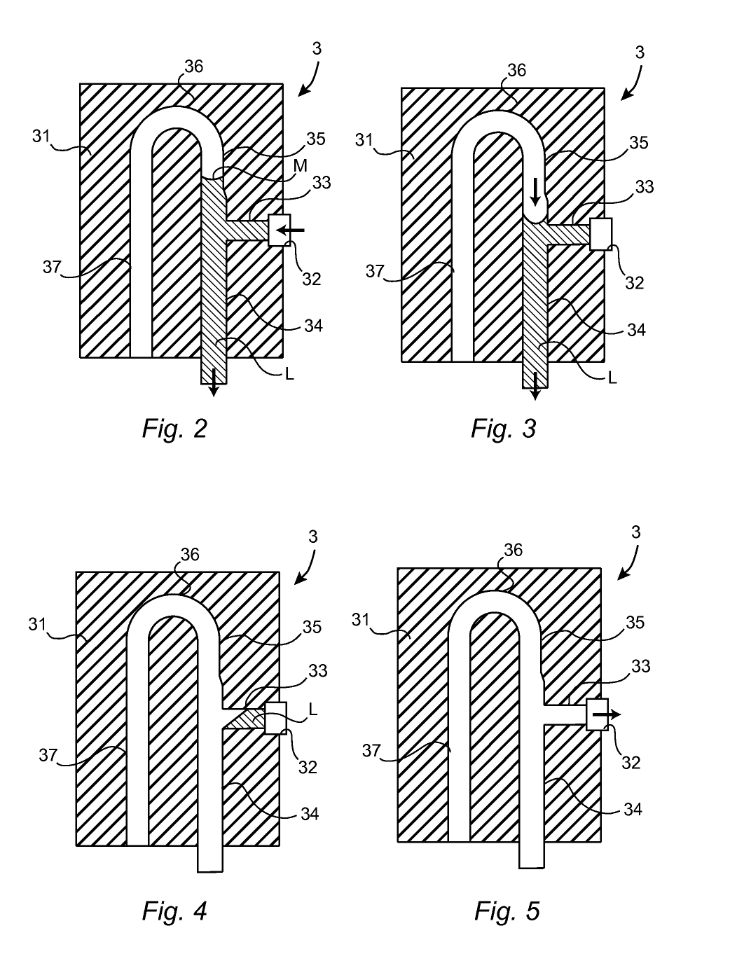

Turning now to FIG. 2, the liquid dispenser 3 of FIG. 1 in this embodiment comprises a body 31 having a liquid inlet 32 that communicates on its upstream side with a conduit in the dispenser arm 4, and that leads to an internal conduit comprising an inlet branch 33 that divides to form a dispensing branch 34 extending downwardly from the inlet branch 33, and a second branch 35 that extends upwardly from the inlet branch 33. The second branch 35 communicates at its distal end with a U-shaped portion 36, which in turn leads to a vertically-oriented vent branch 37.

The dispensing branch 34 and vent branch 37 both open to the ambient at their lower ends. Thus, by appropriate selection of the flow rate of liquid into dispenser 3, and the length and diameter(s) of the internal conduit branches, the liquid in the branch 35 can be maintained at a static level as denoted by the meniscus M in FIG. 2, even as the liquid is discharged downwardly from the lower end of the dispensing branch 34 onto the wafer W undergoing treatment.

When processing of the wafer W is complete, the process valve 6 shown in FIG. 1 is closed. The liquid remaining in the dispenser 3 then drains out of the dispensing branch 34 solely under the influence of gravity, as shown in FIG. 3. That is, the presence of the vent branch 37 and associated branches 35 and 36 causes the liquid to drain smoothly and continuously out of the dispenser 3 through the dispensing branch 34, and prevents the retention of liquid in the dispensing branch 34 that could otherwise be discharged as potentially damaging droplets in an uncontrolled manner.

As shown in FIG. 4, it is possible that some small amount of process liquid L might remain in the inlet branch 33 at the conclusion of processing, in which case it may be removed by a suck-back operation as illustrated in FIG. 5.

The dispensers according to the present invention may thus be used in combination with a suck-back technique to remove any residual liquid, but they do not require the use of such a technique. Thus, whereas conventional liquid dispensers requires sucking the liquid back from the line or blowing the liquid out of the line, to prevent uncontrolled droplet discharge, neither technique is required by the dispensers according to the present invention. Consequently, the additional valves and hardware of such conventional systems is unnecessary in the present dispensers, which results in lower cost and complexity.

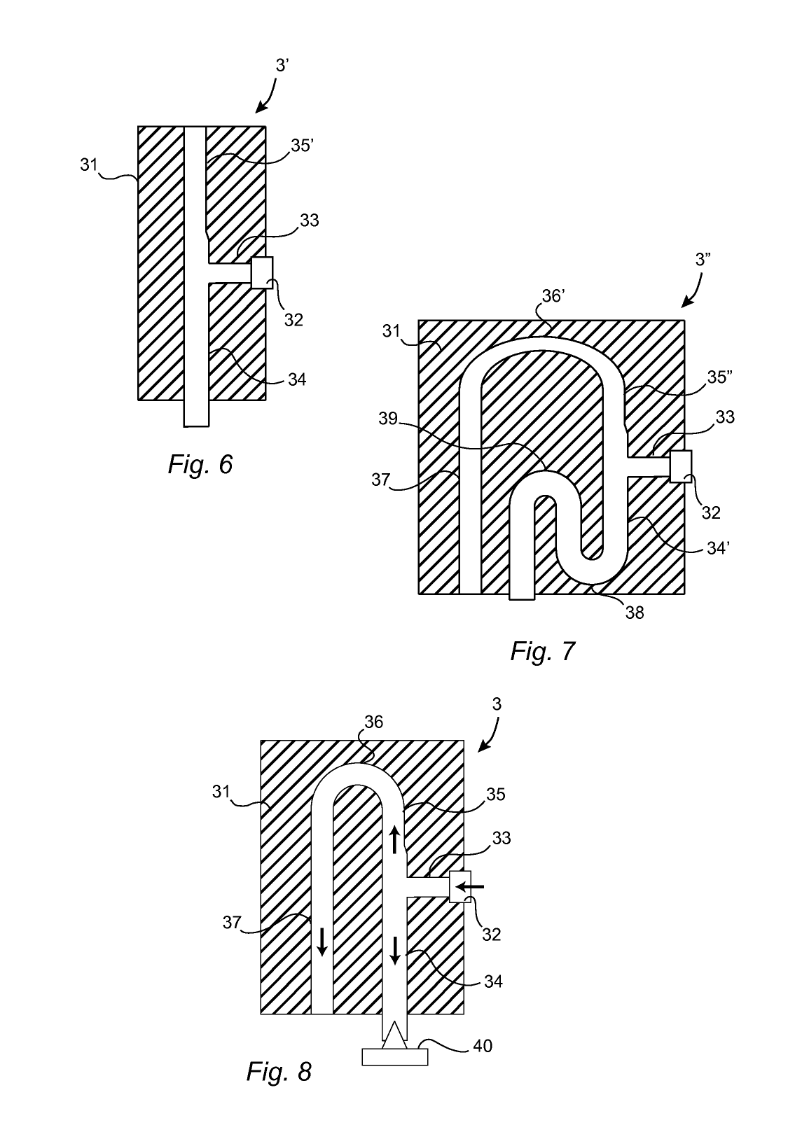

FIG. 6 illustrates a simplified embodiment of a liquid dispenser according to the present invention, which differs from the preceding embodiment in that the branches 36 and 37 are omitted, with the modified second branch 35′ extending to the top of dispenser 3′, where it opens to the exterior ambient to provide the desired venting function. This embodiment, however, lacks the safety function provided by the embodiment of FIGS. 2-5, in that, in the event of blockage of the main flow line, liquid could be sprayed onto the wafer W. The preceding embodiment mitigates this potential issue by having the vent branch extend toward its outlet in the same direction as the dispensing branch.

In the embodiment of FIG. 7, the dispensing branch 34′ has been modified such that it no longer extends along a downward path directly to the discharge opening, but instead leads to a lower U-shaped portion 38, from which the conduit then extends upwardly until it reaches a second U-shaped branch 39. From there, the conduit extends downwardly to the discharge opening. The upper U-shaped portion 36′ of this dispenser 3″ is appropriately reconfigured to accommodate the longer path provided by U-shaped portions 38 and 39.

The dispenser 3″ of FIG. 7 may provide enhanced drip prevention, by creating a pocket of air in the lower U-shaped portion 39 according to a siphon effect.

It should be noted that, in the embodiments of FIGS. 2-5 and 7, the outlets of the discharge and vent branches can if desired be positioned so that, in case of an overflow, the stream of the outlets merge. Such positioning could include a concentric configuration of these outlets. Furthermore, the length and diameter of the dispensing and vent branches can if desired be dimensioned so that the vent branch is used to dispense media when a certain flow is reached.

FIG. 8 illustrates the use of a stopper 40 in a preferred technique for cleaning of a dispenser 3 after use. Specifically, stopper 40 is positioned so as to partially block the outlet of the dispensing branch 34, thereby increasing the pressure drop in that branch and causing a cleaning fluid introduced through inlet 32 to flow not only through branch 34 but also through branches 35, 36, 37.

It will be appreciated from the foregoing description that the dispenser as described herein requires no moving parts, or additional media or power. Furthermore, it is relatively inexpensive and simple to implement, and lends itself well to implementation as a retrofit on processing equipment already in use.

While the present invention has been described in connection with various preferred embodiments thereof, it is to be understood that those embodiments are provided solely to illustrate the invention, and should not be used as a pretext to limit the scope of protection conferred by the true scope and spirit of the appended claims.

What is claimed is:

1. Apparatus for treating a wafer-shaped article, comprising:
a spin chuck for holding and rotating a wafer-shaped article;
a liquid dispenser connected to a supply of a process liquid and positioned or positionable so as to dispense the process liquid onto a surface of a wafer-shaped article when positioned on the spin chuck;
wherein the liquid dispenser comprises a supply conduit that divides to form a first branch extending toward a dispensing outlet of said liquid dispenser and a second branch communicating with a vent opening of said liquid dispenser, said second branch extending upwardly relative to said first branch over at least a portion of its length.

2. The apparatus according to claim 1, wherein said second branch is dimensioned and positioned relative to said first branch so as to maintain a fixed volume of process liquid therein during dispensing of said process liquid through said dispensing opening.

3. The apparatus according to claim 1, wherein said supply conduit and said first and second branches define a T-junction.

4. The apparatus according to claim 1, wherein said first branch extends downwardly from said supply conduit to said dispensing opening.

5. The apparatus according to claim 1, wherein said second branch extends upwardly from said supply conduit to said vent opening.

6. The apparatus according to claim 1, wherein said second branch extends upwardly from said supply conduit to a U-shaped curve, thence downwardly from said U-shaped curve to said vent opening.

7. The apparatus according to claim 1, wherein neither the first branch nor the second branch is equipped with a valve.

8. The apparatus according to claim 1, wherein said first and second branches are dimensioned and positioned relative to one another such that said second branch does not admit air to the first branch though the vent opening, and such that no liquid is discharged through said vent opening.

9. The apparatus according to claim 1, wherein said first branch extends downwardly from said supply conduit to a first U-shaped curve, thence upwardly from said first U-shaped curve to a second U-shaped curve, thence downwardly from said second U-shaped curve to said dispensing opening.

10. The apparatus according to claim 1, further comprising a stopper configured so as to at least partially block said dispensing opening, thereby to promote flushing of said second branch with liquid supplied through said supply conduit.

11. A liquid dispenser for use in an apparatus for treating a wafer-shaped article, comprising:
a supply conduit that divides to form a first branch extending toward a dispensing outlet of said liquid dispenser and a second branch communicating with a vent opening of said liquid dispenser, said second branch extending upwardly relative to said first branch over at least a portion of its length.

12. The liquid dispenser according to claim 11, wherein said second branch is dimensioned and positioned relative to said first branch so as to maintain a fixed volume of process liquid therein during dispensing of said process liquid through said dispensing opening.

13. The liquid dispenser according to claim 11, wherein said supply conduit and said first and second branches define a T-junction.

14. The liquid dispenser according to claim 11, wherein said first branch extends downwardly from said supply conduit to said dispensing opening.

15. The liquid dispenser according to claim 11, wherein said second branch extends upwardly from said supply conduit to said vent opening.

16. The liquid dispenser according to claim 11, wherein said second branch extends upwardly from said supply conduit to a U-shaped curve, thence downwardly from said U-shaped curve to said vent opening.

17. The liquid dispenser according to claim 11, wherein neither the first branch nor the second branch is equipped with a valve.

18. The liquid dispenser according to claim 11, wherein said first and second branches are dimensioned and positioned relative to one another such that said second branch does not admit air to the first branch though the vent opening, and such that no liquid is discharged through said vent opening.

19. The liquid dispenser according to claim 11, wherein said first branch extends downwardly from said supply conduit to a first U-shaped curve, thence upwardly from said first U-shaped curve to a second U-shaped curve, thence downwardly from said second U-shaped curve to said dispensing opening.

20. The liquid dispenser according to claim 11, further comprising a stopper configured so as to at least partially block said dispensing opening, thereby to promote flushing of said second branch with liquid supplied through said supply conduit.
